(19) United States
(12) Patent Application Publication
(10) Pub. No.: US 2015/0154622 A1
(43) Pub. Date: Jun. 4, 2015

(54) VOLUNTEER INCENTIVE SYTEM

(71) Applicant: Servons, Inc., Des Moines, IA (US)

(72) Inventors: Steven B. Schott, Des Moines, IA (US); James L. Phillips, Columbus, OH (US)

(21) Appl. No.: 14/559,440

(22) Filed: Dec. 3, 2014

Related U.S. Application Data
(60) Provisional application No. 61/911,645, filed on Dec. 4, 2013.

(51) Int. Cl. G06Q 30/02

(52) U.S. Cl. CPC G06Q 30/0208

(57) ABSTRACT

A volunteer incentive system where organizations post information about volunteer projects and merchants post information about products and services on an administrator's website. Volunteers join the system and earn redeemable rewards by completing volunteer work.

### CROSS REFERENCE TO RELATED APPLICATION

This application claims the benefit of U.S. Provisional Application No. 61/911,645 filed Dec. 4, 2013.

### BACKGROUND OF THE INVENTION

An objective of the present invention is to provide a volunteer incentive system that encourages a volunteer to repeatedly participate in volunteer projects.

Another objective of the present invention is to provide a volunteer incentive system where a volunteer collects a reward from a merchant for completing volunteer work.

These and other objectives will be apparent to one of skill in the art based upon the following written description, drawings, and claims.

### BRIEF SUMMARY OF THE INVENTION

A volunteer incentive system having an administrator with a controller and a website connected to an electronic network. The controller is accessed by organizations through a first interface, by merchants through a second interface and by volunteers through a third user interface. Organizations post information about volunteer projects and merchants post information about rewards related to products and services. Volunteers join the system, earn rewards by completing volunteer work, and redeem the rewards from merchants.

### BRIEF DESCRIPTION OF THE FIGURES

FIG. 1 is a schematic drawing of the environment of a volunteer incentive system.

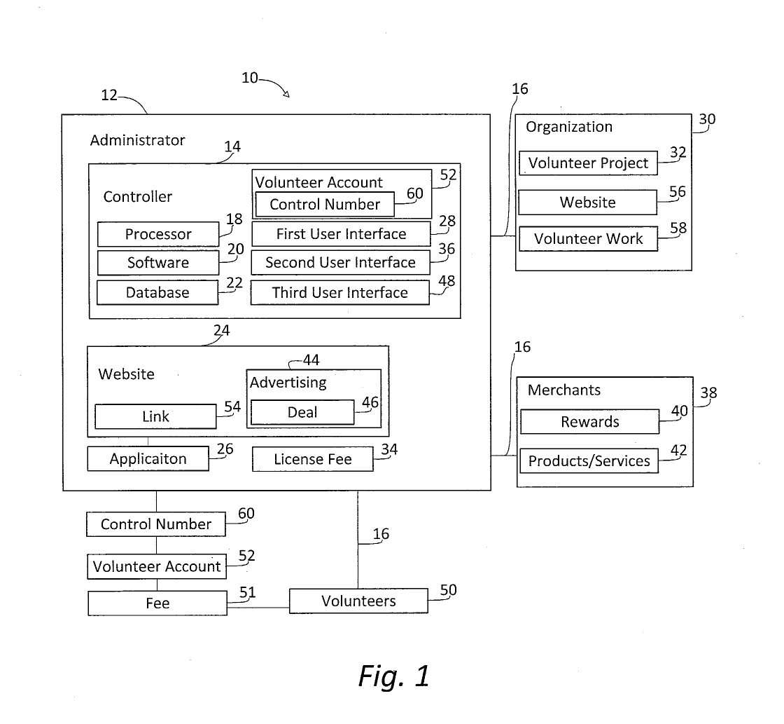

FIG. 2 is a flow diagram of a volunteer incentive system.

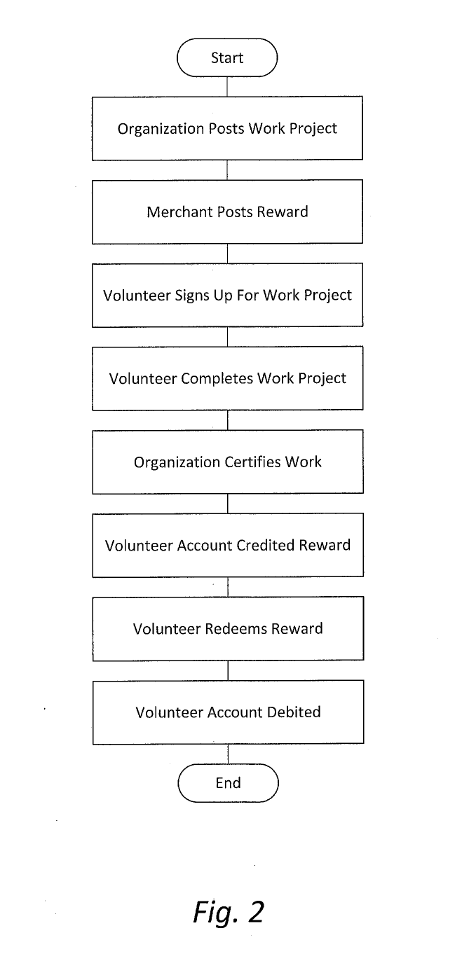

### DETAILED DESCRIPTION OF THE PREFERRED EMBODIMENT

Referring to the Figures, a volunteer incentive system 10 includes an administrator 12 having a controller 14 connected to an electronic network 16, such as the internet. The controller 14 includes a processor 18, software 20, and a database 22. The controller 14 supports a website 24 and a downloadable telephone application 26. Website 24 is accessible through the internet whereas, application 26 is downloadable onto a cellular phone or other device and provides direct access the system 10.

The controller 14 has a first user interface 28 that permits an organization 30 in need of volunteers to post information related to a volunteer project 32. The organization 30 is of any type of an organization and in one arrangement is a non-profit organization such as Habitat For Humanity, Boy or Girl Scouts, the Humane Society, church groups, Susan G. Komen, any other charitable organizations, as examples. Volunteer projects 32 is any type of an event such as a race or walk, building houses, cleaning up neighborhoods, concerts, gatherings, fairs, or the like. In one embodiment of the system 10 the organization pays a license fee 34 to the administrator 12 in order to post volunteer project information 32 and have access to the system 10. License fee 34 can be a one-time use fee, a pay per post or use fee, a monthly, quarterly or annually paid fee, or any other type of fee.

The controller 14 has a second user interface 36 that permits merchants 38 to post information about rewards 40 that may be redeemed at the merchants' place of business. Merchants 38 are any type of a goods or service provider such as stores, restaurants, service providers such as plumbers, mechanics, lawn care, or any other entity that sells goods or services. Like organization 30, merchants 38 pay a license fee 34.

The rewards 40 are tied or linked to selected products and/or services 42 and permit the redemption of rewards 40 for the purchase or discount on a purchase of the selected product and/or service 42. The selected product and/or service 42 may be tied to a specific volunteer project 32. That is, when a user of the system 10 participates in the volunteer project 32, they are entitled to a reward 40 for the linked product and/or service 42 from merchant 38.

Merchants 38 and organizations 30, together or separately, may purchase advertising 44 that is placed on the website 24 and/or the downloadable application 26. In one arrangement, the advertising 44 is directed towards promoting the organization 30 and the cause or purpose the organization 30 is devoted towards. In another arrangement, the advertising 44 is directed towards promoting the volunteer project 32 and the cause or purpose for the volunteer project 32. In another arrangement, the advertising 44 is directed to promoting the merchant 38 and/or the products and/or services 42 the merchant 38 offers. In another arrangement, the advertising 44 is directed to promoting the rewards 40 offered by the merchant 38 for the products and/or services 42 the merchant 38 offers. Advertising is also used to solicit donations to the organization 30 and/or the volunteer project 32.

In yet another arrangement, the advertising 44 is directed to promoting a deal 46 offering the redemption of rewards 40 in full or partial payment of promotional products or services 42. Or alternatively, deal 46 includes offering additional rewards 40 (such as double rewards for signing up for the volunteer project 32 within a specified amount of time) to promote the merchant 38, the organization 30, the volunteer project 32 and/or the products and/or services 42. In yet another arrangement, advertising 44 is not specifically related to the organization 30, volunteer project 32, merchant 38 or products and/or services 42 and is instead paid for advertising by third parties to promote goods and/or services.

The controller 14 also has a third user interface 48 that permits volunteers 50 to join the system 10. Preferably, volunteers 50 join the system 10 by paying a fee 51, such as a one-time use fee, a pay per use fee, a monthly, quarterly or annually paid fee, or any other type of fee. By joining the system 10, the controller 14 creates a volunteer account 52 tied to each volunteer 50. A volunteer account 52 is tied to an individual or a group such as a little league team, Boy Scout or Girl Scout troop, or the like.

In operation, both organizations 30 and merchants 38 sign up for the system 10 and pay their license fee 34. Organizations 30 post information about the volunteer project 32 and merchants 38 link selected products and/or services 42 to the organization 30 and/or volunteer project 32. Volunteers 50 access the website 24 or application 26 and sign up for a volunteer project 32. A volunteer 50 signs up for a project 32 either on or through the website 24 or application 26 or through a link 54 to an organization's 30 website 56.

Upon completion of volunteer work 58 the organization 30 certifies that the work has been completed by each volunteer 50 that participated or attended and rewards 40 are credited to the volunteer's account 52 by the controller 14. Certification may occur by scanning a bar code or RFID or otherwise detecting or entering a control number 60 issued by the controller 14 to the volunteer 50 and/or the organization 30. As an example, a volunteer 50 earns one reward credit 40 for one hour of volunteer work 58 completed.

To redeem rewards 40, a volunteer 50, using the issued control number 60 may purchase the selected product or service 42 either through the website 24, or by presenting the control number 60 at the merchant's 38 place of business or through the website 24, through the application 26, or through the internet, or in any other manner to cause redemption to occur. Alternatively, a volunteer 50 may donate their rewards 40 to an organization 32 wherein the organization 32 may redeem the rewards 40 themselves to further promote their cause or purpose. In one arrangement, rewards 40 may not be purchased and can only be earned by completing volunteer work 58. In an alternative arrangement, additional rewards 40 can be purchased through the system. Upon redemption, the controller 12 automatically debits rewards 40 from the volunteer's account 52 and transmits whatever payment is required to merchant 38.

Based upon criteria 62 provided by the volunteer 50 or on volunteer work 58 completed by the volunteer 50 the controller 12 sends electronic notifications of similar volunteer projects 42 to the volunteer 50.

A benefit of the system 10 is to encourage and promote a volunteer 50 to repeatedly participate in volunteer projects 32 and to be involved with organizations 30. By doing so, this causes the volunteer 50 to repeatedly return to the system 10 through website 24 and/or application 26 through which the volunteer 50 will become aware of other organizations 30 and/or volunteer projects 32 through advertising 44 and promotional deals 46. The system 10 allows the volunteer 50 to collect rewards 40 from disparate or unrelated organizations 30 or volunteer projects 32. That is, the volunteer 50 can volunteer one weekend for the Humane Society and the next weekend for Habitat for Humanity and collect and accumulate rewards in a single volunteer account 52 which benefits both the organizations 30 (by having participants) and the volunteer 50 (by collecting and accumulating rewards). This also benefits the merchants 38 through increased patronage. In this way the system 10 promotes involvement with organizations 30 and participation in volunteer projects 32, while benefiting the volunteer 50 through the accumulation of rewards 40 while promoting additional patronage of associated merchants 38. Accordingly all the stated goals of the system 10 have been accomplished.

What is claimed is:

1. A volunteer incentive system, comprising:
an administrator having a controller and a website connected to an electronic network;
an organization that posts information related to a volunteer project through a first user interface of the controller;
a merchant that posts information related to a reward through a second user interface;
a volunteer who joins the system through a third user interface of the controller;
wherein the controller creates a volunteer account related to the volunteer, credits the reward to the volunteer account upon certification by the organization that volunteer work has been completed by the volunteer, and debits the volunteer account when the volunteer redeems the reward from the merchant.

2. The system of claim 1 further comprising a telephone application that is downloadable from the website.

3. The system of claim 1 where advertising is purchased from a group consisting of the organization, the merchant, and a third party.

4. The system of claim 3 wherein the advertising is directed to promoting a deal.

5. The system of claim 1 wherein certification occurs from detecting a control number issued by the controller.

6. The system of claim 1 wherein the volunteer donates the reward to the organization and the organization redeems the award.

7. The system of claim 1 wherein the controller sends notifications of similar volunteer projects based upon the volunteer work completed by the volunteer.

8. The system of claim 5 wherein the reward is redeemed using the control number.

9. The system of claim 1 wherein the controller sends notifications to the volunteer based upon criteria provided by the volunteer.

10. The system of claim 1 wherein the reward is tied to the volunteer project.

11. The system of claim 1 wherein a volunteer accumulates rewards from completing more than one volunteer project.
